(19) United States
(12) Patent Application Publication
(10) Pub. No.: US 2020/0141612 A1
(43) Pub. Date: May 7, 2020

(54) TEMPERATURE AND PRESSURE VALVE WITH PUSH-TO-CONNECT FITTING

(71) Applicant: Reliance Worldwide Corporation, Atlanta, GA (US)

(72) Inventor: Albert William Thibodeaux, JR., Decatur, GA (US)

(73) Assignee: Reliance Worldwide Corporation, Atlanta, GA (US)

(21) Appl. No.: 16/178,019

(22) Filed: Nov. 1, 2018

(51) Int. Cl. F24H 9/20; F16K 17/02; F16K 17/38

(52) U.S. Cl. CPC F24H 9/2035; F16L 37/40; F16K 17/38; F16K 17/02

(57) ABSTRACT

A temperature and pressure valve includes a body, an inlet section, an outlet section, and a valve. The inlet section extends from the body and is configured to receive a fluid. The outlet section extends from the body and is structured to house a push-to-connect fitting. The valve is positioned between the inlet and outlet sections and is movable between a closed position and an open position. The valve is configured to move from the closed position to the open position when the fluid exceeds at least one of a threshold pressure or a threshold temperature. When the valve is in the open position, the inlet section and outlet section are in fluid communication.

### FIELD

The present disclosure relates generally to the field of water heaters.

### BACKGROUND

In general, a water heater intakes cold water to a tank, heats the water in the tank, and provides the heated water to a plumbing system for provision to faucets, appliances, etc. throughout a building. To avoid excess temperature or pressure buildup in the water heater tank, which could lead to an explosion or other damage, most water heaters include a temperature and pressure valve (T&P valve) that provides relief from high temperatures and pressures. In general, T&P valves are configured to open in response to a threshold temperature and/or threshold pressure in the water heater tank to allow fluid (e.g., water, vapor, steam, air) to escape the tank to ensure that the temperature and the pressure stay within safe limits. T&P valves are typically connected to a tube or pipe that directs fluid discharged through the valve to a suitable drain. However, conventional connections between T&P valves may be hard to install and may be prone to leaks.

### SUMMARY

The present disclosure relates to temperature and pressure valves with push-to-connect fittings that facilitate quick, tool-free, and cost-saving installation and substantially eliminate leaks between temperature and pressure valves and a discharge tubes or pipes.

One implementation of the present disclosure is a temperature and pressure valve. The temperature and pressure valve includes a body, an inlet section, an outlet section, and a valve. The inlet section extends from the body and is configured to receive a fluid. The outlet section extends from the body and is structured to house a push-to-connect fitting. The valve is positioned between the inlet and outlet sections and is movable between a closed position and an open position. The valve is configured to move from the closed position to the open position when the fluid exceeds at least one of a threshold pressure or a threshold temperature. When the valve is in the open position, the inlet section and outlet section are in fluid communication.

Another implementation of the present disclosure is a water heater. The water heater includes a tank configured to store fluid, a discharge port in fluid communication with the tank, and a temperature and pressure valve coupled to the discharge port. The temperature and pressure valve includes an inlet extending from a body and in fluid communication with the discharge port and an outlet extending from the body and housing a push-to-connect fitting. A valve is positioned between the inlet and the outlet and moveable between a closed position and an open position. The valve is configured to move from the closed position to the open position when the fluid exceeds at least one of a threshold pressure and a threshold temperature. The inlet and the outlet are in fluid communication when the valve is in the open position.

Another implementation of the present disclosure is a method of manufacturing a temperature and pressure valve. The method includes forming a body as a single housing. The body includes an inlet and a substantially cylindrical outlet, and the inlet is in fluid communication with the outlet. The outlet has an outside end, a wall extending from the body to the outside end and having an inner surface and an outer surface, a first section that has a first radius, and a second section positioned between the first section and the second end and having a second radius. The second radius may be larger than the first radius. An inner ledge on the inner surface and an outer ledge on the outer surface define a transition from the first section to the second section. The method also includes installing a push-to-connect fitting in the outlet.

### BRIEF DESCRIPTION OF THE DRAWINGS

FIG. 1 is an illustration of a water heater with a temperature and pressure valve, according to an exemplary implementation.

FIG. 2 is a cross-sectional view of the temperature and pressure valve of FIG. 1, according to an exemplary implementation.

FIG. 3 is a process diagram illustrating a method according to an exemplary implementation.

FIG. 4A is an exploded view of a push-to-connect fitting according to an exemplary implementation.

FIG. 4B includes perspective views of elements depicted in FIG. 4A.

FIG. 5A is a perspective view of the valve shown in FIG. 2 according to an exemplary implementation.

FIG. 5B is a side view of the valve shown in FIG. 2 according to an exemplary implementation.

### DETAILED DESCRIPTION

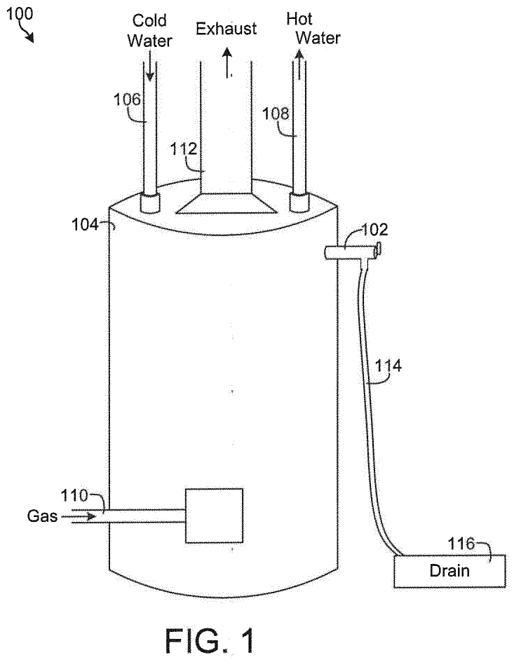

Referring to FIG. 1, a water heater 100 with a temperature and pressure valve (T&P valve) 102 is shown, according to an exemplary implementation. The water heater 100 includes a tank 104, fluidly communicable with a cold water intake pipe 106, a hot water output pipe 108, and the temperature and pressure relief valve 102. The water heater 100 heats cold water that enters the tank 104 through the cold water intake pipe 106 to produce hot water that leaves the tank 104 through the hot water output pipe 108. As shown in FIG. 1, the water heater 100 is a gas water heater configured to transform natural gas, provided to the water heater 100 via gas pipe 110, into heat energy to heat water in the tank 104. The gas is burned to generate heat, and the exhaust is safely expelled via exhaust vent 112. In other implementations, the water heater 100 is an electric water heater that uses electrical energy to provide heat to the water in the tank 104.

The tank 104 has a substantially fixed volume. As heat is provided to the water in the tank 104 (i.e., water provided via cold water intake pipe 106), the temperature of the water rises and the water expands. At high temperatures, the water may transition from a fluid to a gaseous state, so that the tank 104 contains steam and/or water vapor. Other gases (e.g., air) contained within the tank 104 are also heated, increasing the pressure in the tank 104. Thus, as heat is provided to the tank 104, the pressure in the tank 104 may also increase. Under ideal conditions, the amount of heat energy provided to the tank 104 by heating elements (e.g., gas burner, electric heater) is tuned to the rate of cold water intake and hot water output such that the temperature and pressure within the tank 104 are preserved at desired levels.

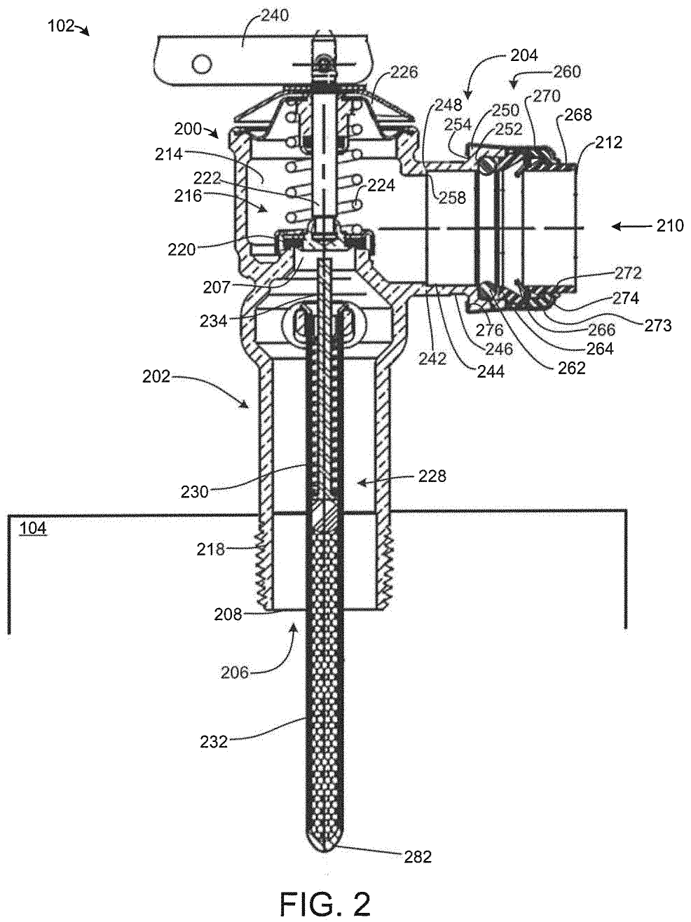

However, in some cases, the temperature and pressure may exceed safe levels. For example, if the pressure in the tank 104 exceeds atmospheric pressure and the tank 104 cannot contain or safely discharge the excess pressure, the water heater 100 may be damaged or may rupture. Water heater 100 therefore includes a T&P valve 102. As described in detail with reference to FIG. 2, the T&P valve 102 automatically actuates from a closed position to an open position in response to the temperature in the tank 104 exceeding a threshold temperature or a pressure in the tank 104 exceeding a threshold pressure. In the open position, gas and fluid can escape the tank 104 through the T&P valve 102 to help regulate the temperature and pressure in the tank 104. The T&P valve 102 therefore allows safe operation of water heater 100.

As shown in FIG. 1, a tube (e.g., a pipe or flexible hose) 114 is coupled to the T&P valve 102 and runs from the T&P valve 102 to a drain 116. Fluid discharged from the tank 104 through the T&P valve 102 is directed through tube 114 to the drain 116. A substantially water-tight seal is needed between the tube 114 and the T&P valve 102 to ensure that all fluid discharged via the T&P valve 102 reaches the drain 116 without dripping on components of water heater 100, other appliances, the floor, or other objects. As described in detail with respect to FIG. 2, the T&P valve 102 can be easily and quickly sealed to the tube 114 using a push-to-connect fitting.

Referring now to FIG. 2, a detailed view of the T&P valve 102 is shown, according to an exemplary implementation. The T&P valve 102 includes a body 200, an inlet section (also referred to as an ‘inlet’) 202 extending from the body 200 in a first direction, and an outlet section 204 extending from the body 200 in a second direction perpendicular to the first direction. The body 200, the inlet section 202, and the outlet section 204 are formed from a single housing (e.g., in a single casting or single forging). The inlet section 202 is substantially cylindrical, with an inlet channel 206 extending through the inlet section 202 in the first direction from an opening 207 at the body 200 to a first end 208. The outlet section 204 is also substantially cylindrical, with an outlet channel 210 extending through the outlet section 204 from the body 200 to a second end 212 in the second direction. An inner volume 214 of the body 200 is in fluid communication with the outlet section 204. A valve 216 is positioned between the inlet section 202 and the outlet section 204, and is moveable between a closed position and an open position. When the valve 216 is in the open position, the inlet channel 206 is in fluid communication with the inner volume 214 and the outlet channel 210. When the valve 216 is in the closed position (as shown in FIG. 2), the valve 216 substantially prevents the flow of fluid from the inlet channel 206 to the inner volume 214 and the outlet channel 210.

The inlet section 202 includes threading 218. Threading 218 is configured to engage a discharge port of water heater tank 104. The threading 218 engages the discharge port of the tank 104 to couple the T&P valve 102 to the tank 104. When the T&P valve 102 is coupled to the tank 104, the inlet channel 206 is in fluid communication with the tank 104.

Valve 216 includes a stopper 220 positioned at the opening 207 between the inner volume 214 of the body 200 and the inlet channel 206, a shaft 222 extending from the stopper 220 through the inner volume 214 and through a top cover 226 of the body 200, a spring 224 in contact with the stopper 220 and the top cover 226 and spiraled around the shaft 222, and a thermal unit 228 positioned in the inlet channel 206.

When the temperature and pressure in the tank 104 are below threshold limits, the spring 224 holds the stopper 220 against the opening 207 to seal the opening 207. Under such conditions, the stopper 220 seals the inlet channel 206, substantially preventing fluid (e.g., water, steam, vapor, air) from escaping the tank 104 through the T&P valve 102. In such cases, the valve 216 is said to be in the “closed” position.

As the pressure in the tank 104 rises, the pressurized air/steam/vapor/etc. in the tank 104 exerts an increasing force against the stopper 220 from the inlet channel 206 towards the inner volume 214. Above a threshold pressure, the force exerted against the stopper 220 by the pressurized fluid exceeds the opposing force of the spring 224 that holds the stopper 220 against the opening 207. The pressure then compresses the spring 224 and displaces the stopper 220 from the opening 207 to unseal the opening 207. The shaft 222 partially slides through the top cover 226. The valve 216 is thereby transitioned to the “open” position, and the inlet channel 206 is in fluid communication with the inner volume 214 and the outlet channel 210. When the pressure in the tank 104 decreases, the spring 224 forces the stopper 220 back against the opening 207 to repeal the opening 207 and return the valve 216 to the “closed” position.

The thermal unit 228 is a regulator that extends into the tank 104 and includes a cylinder 230 coupled to the inlet section 202, working substance 232 within the cylinder 230, and a rod 234 extending out of the cylinder 230 towards the stopper 220. The thermal unit 228 has a tapered end 282 at an opposite end from stopper 220. The working substance may be wax, in at least one exemplary implementation. The working substance, as may also be called a working fluid, is a material with a high coefficient of expansion, such that when the working fluid 232 increases in temperature, the volume of the working fluid 232 expands significantly relative to other components of the water heater 100. The rod 234 is slideable along the cylinder 230 and is positioned to confine the working fluid 232 in the cylinder 230. In some implementations, the thermal unit includes a temperature probe.

When the working fluid 232 expands (i.e., when the temperature in the tank 104 increases), the working fluid 232 forces the rod 234 to slide partially out of the cylinder 230 and towards the stopper 220. Above a threshold temperature in the tank 104, the working fluid 232 expands enough to push the rod 234 against the stopper 220 with enough force to displace the stopper 220 from the opening 207 (i.e., a force stronger than the opposing force exerted by the spring 224). Thus, at temperature above the threshold temperature, the thermal unit 228 moves the valve 216 to the open position, providing fluid communication between the inlet channel 206, the inner volume 214, and the outlet channel 210.

When the temperature decreases to be below the threshold temperature in the tank 104, the volume of working fluid 232 is lowered enough that the rod 234 no longer supports the force of the spring 224. The spring 224 then forces the stopper 220 back to the opening 207 to seal the opening 207 and forces the rod 234 to retreat partially into the cylinder 230. The valve 216 is thereby returned to the closed position.

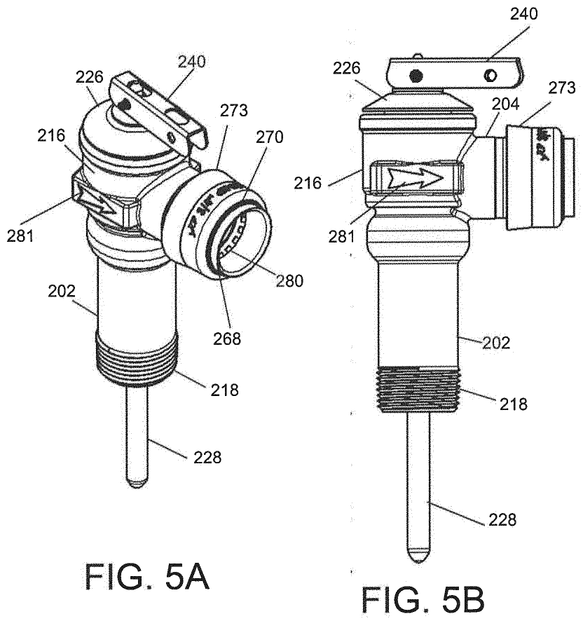

FIGS. 5A and 5B show perspective and side views of the temperature and pressure valve shown in FIG. 2 according to an exemplary implementation. As seen in FIGS. 5A and 5B, the valve 216 also includes a handle 240 coupled to the shaft 222 and positioned outside of the body 200 proximate the top cover 226. The handle 240 is configured to be manipulated by a user to open or close the valve 216, e.g., by twisting, pushing, or pulling, etc. the handle 240 to cause the valve 216 to move to the open position. The valve 216 may be provided with an indicator 281 (e.g., a marking) indicating a direction of flow.

The valve 216 is thereby configured to move to the open position in response to a pressure in the tank 104 exceeding a threshold pressure, a temperature in the tank 104 exceeding a threshold temperature, or a user manipulation of the handle 240. When the valve 216 is in the open position, fluid can flow from the tank 104 to the outlet channel 210.

The outlet section 204 is configured to house a push-to-connect fitting 260 that couples a tube 114 to the outlet section 204 in fluid communication with the outlet channel 210. The outlet section 204 is substantially cylindrical with a wall 242 extending from the body 200 to the second end 212. The wall 242 has an inner surface 244 that defines the outlet channel 210 and an outer surface 246. The outlet section 204 includes a first section 248 proximate the body 200 that has a first radius and a second section 250 positioned between the first section 248 and the second end 212. The second section 250 has a second radius. The second radius is larger than the first radius. An inner ledge 252 on the inner surface 244 and an outer ledge 254 on the outer surface 246 define the transition from the first-section 248 to the second section 250. A backstop 258 protrudes from the inner surface 244 of the first section 248 proximate the body 200.

The push-to-connect fitting 260 is configured to allow a user to couple the tube 114 to the outlet section 204 in a leak free fluid communication with the outlet channel 210 by simply pushing the tube 114 into the outlet channel 210 to engage the push-to-connect fitting 260. The push-to-connect fitting 260 includes an O-ring 262 positioned to abut the inner ledge 252, an O-ring protector 264 that abuts the O-ring 262, a grab ring 266 that abuts the O-ring protector 264, an inner demount ring 268 that abuts the grab ring 266, a cartridge ring 270 that engages the inner demount ring 268 and O-ring protector 264, and a cap 273 crimped to engage the outer ledge 254 and the cartridge ring 270 and secure the O-ring 262, the O-ring protector 264, the grab ring 266, and the inner demount ring 268 in the outlet channel 210.

The O-ring 262 is configured to substantially prevent fluid from leaking between the tube 114 and the push-to-connect fitting 260 (i.e., between the tube 114 and the inner surface 244 of the wall 242 of the outlet section 204) when the push-to-connect fitting 260 receives the tube 114. The O-ring 262 is positioned along the circumference of the outlet channel 210 such that the O-ring 262 is configured to receive the tube 114. The O-ring 262 may be made of a resilient polymer that can be compressed repeatedly by the tube 114, such that the O-ring 262 compresses around the tube 114 and presses against the tube 114 to create a seal around the tube 114.

The O-ring protector 264 is configured to contain and protect the O-ring 262 from damage from the grab ring 266 and/or the tube 114. For example, the grab ring 266 may be made of a metal substantially harder than the compressible O-ring 262. The O-ring protector 264 is positioned between the O-ring 262 and the grab ring 266 to protect the O-ring 262 from being scratched, torn, abraded, punctured or otherwise damaged by the harder material of the grab ring 266.

The grab ring 266 is configured to substantially secure the tube 114 in the outlet channel 210. In some implementations, the grab ring 266 includes an outer rim that surrounds the outlet channel 210 and a plurality of teeth 280 extending from the outer rim into the outlet channel 210. The teeth engage the tube 114 when the tube 114 is received by the outlet channel 210 to secure the tube 114 in the outlet channel 210. In some implementations, the push-to-connect fitting 260 includes a release that allows a user to disengage the grab ring 266 from the tube 114 to remove the tube 114 from the push-to-connect fitting 260.

The inner demount ring 268 is configured to align the tube 114 in fluid communication with the outlet channel 210. The inner demount ring 268 protrudes from the second end 212 of the outlet section 204 and includes a wall 272 surrounding the outlet channel 210. The wall 272 is configured to receive the tube 114 and insure that the tube 114 slides into the push-to-connect fitting 260 in a proper orientation. The sleeve wall 272 also provides structural support that facilitates coupling of the tube 114 to the outlet channel 210. The inner demount ring 268 is configured to allow removal of the push to connect fitting from the tube 114. The inner demount ring 268 and cartridge ring 270 collectively make up a sleeve assembly according to at least one implementations.

The cap 273 is configured to secure the O-ring 262, the O-ring protector 264, the grab ring 266, the demount ring 268, and the cartridge ring 270 in the outlet channel 210. The cap 273 is a cylindrical shell that surrounds the push-to-connect fitting 260 and the second section 250. The cap 273 is an outer ring (outer sleeve) that includes a first lip 274 that engages the cartridge ring 270 and a second lip 276 that engages the outer ledge 254. The cap 273 thereby secures the cartridge ring 270 and ensures that the O-ring 262 securely abuts the inner ledge 252, the O-ring protector 264 securely abuts the O-ring 262, the grab ring 266 securely abuts the O-ring protector 264, and the demount ring 268 securely abuts the grab ring 266 to couple the push-to-connect fitting 260 to the outlet section 204.

To assemble the push-to-connect fitting 260 in the T&P valve 102, the O-ring 262 is positioned abutting the inner ledge 252, the O-ring protector 264 is positioned abutting the O-ring 262 with the grab ring 266 positioned abutting the O-ring protector 264, the demount ring 268 positioned abutting the grab ring 266, and the cartridge ring 270 securing these components to form a cartridge. The cap 273, initially formed without the second lip 276, is slid over the components 262-270 and the second section 250 of the outlet section 204 such that the first lip 274 engages the cartridge ring 270. The cap 273 is then crimped (e.g., bent) to engage the outer ledge 254 by forming the second lip 276. The push-to-connect fitting 260 is thereby installed in the single housing of the T&P valve 102.

To install a tube 114 with the T&P valve 102, the tube 114 is pushed into the push-to-connect fitting 260. The tube 114 extends snugly through the O-ring 262, the O-ring protector 264, the grab ring 266, and the demount ring 268 in the outlet channel 210. The backstop 258 prevents the tube 114 from sliding beyond a preferred position into the T&P valve 102 (e.g., prevents the tube 114 from sliding too far into the body 200). In this manner, the backstop prevents interference between the tube 114 and the valve 216. The O-ring 262 seals around the tube 114, and the grab ring 266 secures the tube 114 in the outlet channel 210. The tube 114 is then in substantially a leak-free fluid communication with the inner volume 214, and, when the valve 216 is in the open position, with the inlet channel 206 and the tank 104. Fluid discharged from the tank 104 via the T&P valve 102 is thereby directed from the T&P valve 102 through the tube 114 to a drain 116.

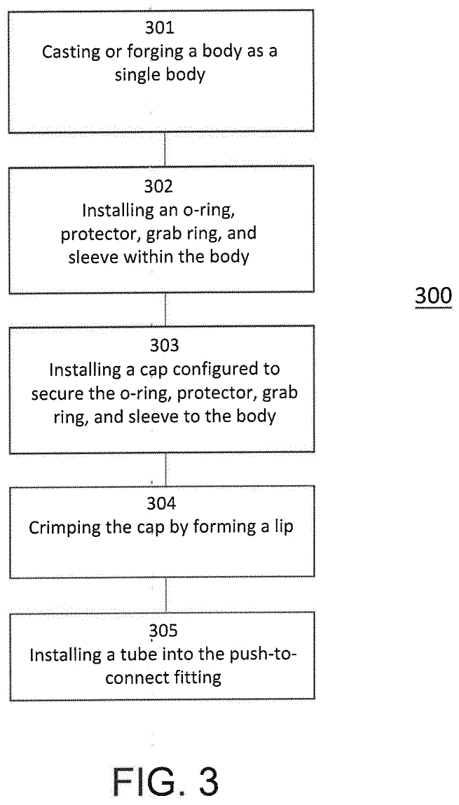

FIG. 3 depicts a method 300 for manufacturing a temperature and pressure valve 102 (excluding operating mechanisms such as the thermal unit 228 and valve 216) according to an exemplary implementation of the present disclosure. The method 300 includes forming a body as a single casting or forging (step 301), the body 200 comprising an inlet 202 and an outlet 204. Specifically, the body 200 includes an inlet 202 and a substantially cylindrical outlet 204, where the inlet 202 is in fluid communication with the outlet 204. The outlet 204 has an outside end 212, a wall 242 extending from the body 200 to the outside end 212, and having an inner surface 244 and an outer surface 246, a first section 248 that has a first radius, and a second section 250 positioned between the first section 248 and the second end 212 and having a second radius. The second radius may be larger than the first radius. An inner ledge 252 on the inner surface 244 and an outer ledge 254 on the outer surface 246 define a transition from the first section 248 to the second section 250.

Referring back to FIG. 3, the method 300 also generally includes installing a push-to-connect fitting in the outlet. Specifically, the method 300 includes installing an O-ring 262, an O-ring protector 264, a grab ring 266, and a sleeve assembly made up of the demount ring 268 and cartridge (outer ring) sleeve 270 within the body 200 (step 302). The O-ring 262 is installed to be positioned along the circumference of the outlet channel 210 such that the O-ring 262 is configured to receive the tube 114, and where the O-ring 262 is abutting the inner ledge 252. The O-ring protector 264 is installed to be positioned abutting the O-ring 262. The grab ring 266 is installed to be positioned abutting the O-ring protector 264. The demount ring 268 is installed to be positioned abutting the grab ring 266.

The method 300 further includes the step of installing a cap 273 which is configured to secure the O-ring 262, O-ring protector 264, grab ring 266, and sleeve assembly to the body (step 303). The cap 273 is slid over the components 262-270 and the second section 250 of the outlet section 204 such that the first lip 274 engages the cartridge ring 270. The method 300 includes next crimping the cap by forming a lip (step 304). Specifically, the cap 273 is crimped (e.g., bent) to engage the outer ledge 254 by forming a second lip 276. The push-to-connect fitting 260 is thereby installed in the single housing body 200.

The method 300 further includes the step of installing a tube 114 into the push-to-connect fitting 260 (step 305). To install the tube 114, the tube 114 is pushed into the push-to-connect fitting 260, such that the tube 114 extends through the O-ring 262, the O-ring protector 264, the grab ring 266, and the sleeve assembly in the outlet 210. The method includes sealing the tube 114 by providing the O-ring 262 around the tube 114, and securing the tube 114 with the grab ring 266 in the outlet channel 210.

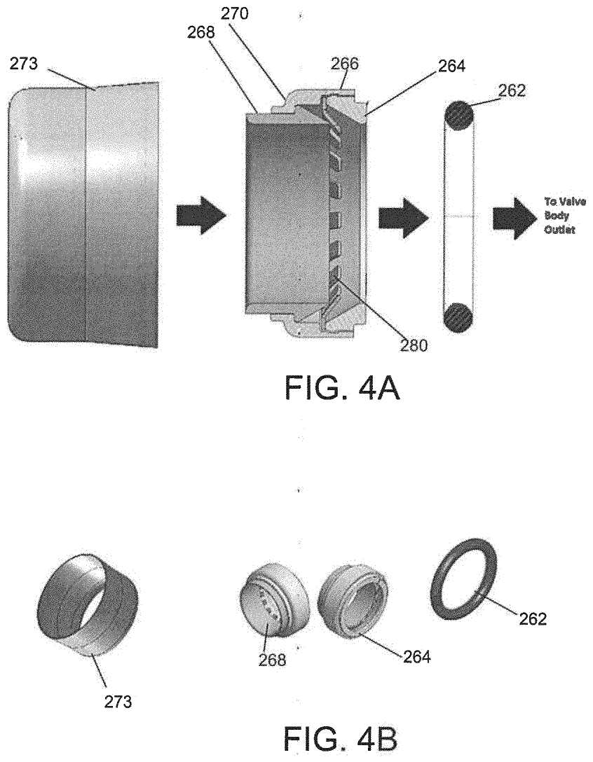

FIG. 4A depicts an exploded view of a push-to-connect fitting as may be assembled with the T&P valve 102 according to one or more implementations. As shown in FIG. 4A, an O-ring may be disposed at a first side of the sleeve assembly that is made up of the cartridge ring 270 and the demount ring 268. The protector ring 264 abuts the O-ring 262, and the grab ring 266 is arranged such that the protector ring 264 sits between the O-ring 262 and the grab ring 266. The cap 273, as may also be referred to as a nose cone, has a larger diameter than the outermost portion of the sleeve assembly (i.e., the upper surface of the cartridge ring 270) so as to slide over the sleeve assembly. In this manner, a convenient and easy-to-use fitting may be provided to connect the T&P valve to a tank.

FIG. 4B shows perspective views of the cap 273, the demount ring 268, the grab ring 266 and the O-ring 262.

As utilized herein, the terms “approximately,” “about,” “substantially,” “proximate” and similar terms are intended to have a broad meaning in harmony with the common and accepted usage by those of ordinary skill in the art to which the subject matter of the disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

The terms “coupled,” “connected” and the like are used herein to mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” “above,” “below,” etc.) are merely used to describe the orientation of various elements in the Figures. It should be noted that the orientation of various elements may differ according to other exemplary implementations and that such variations are intended to be encompassed by the present disclosure.

It is to be understood that although the present invention has been described with regard to certain implementations thereof, various other implementations and variants may occur to those skilled in the art, which are within the scope and spirit of the invention, and such other implementations and variants are intended to be covered by corresponding claims. Those skilled in the art will readily appreciate that many modifications are possible (e.g., variations in sizes, structures, shapes and proportions of the various elements, mounting arrangements, use of materials, orientations, etc.) without materially departing from the novel teachings and advantages of the subject matter described herein. For example, the order or sequence of any process or method steps may be carried or re-sequenced according to alternative implementations. Other substitutions, modifications, changes, and omissions may also be made in the design, operating conditions and arrangement of the various exemplary implementations without departing from the scope of the present disclosure.

With respect to the use of substantially any plural and/or singular terms herein, those having skill in the art can translate from the plural to the singular and/or from the singular to plural as is appropriate to the context or application. The various singular/plural permutations may be expressly set forth herein for clarity.

What is claimed is:

1. A temperature and pressure valve, comprising:
a body;
an inlet section extending from the body and configured to receive a fluid;
an outlet section extending from the body and structured to house a push-to-connect fitting; and
a valve positioned between the inlet and the outlet sections and movable between a closed position and an open position, the valve configured to move from the closed position to the open position when the fluid exceeds at least one of a threshold pressure or a threshold temperature, the inlet section and the outlet section being in fluid communication when the valve is in the open position.

2. The temperature and pressure valve of claim 1, wherein the push-to-connect fitting comprises an O-ring, an O-ring protector, a grab ring, a sleeve assembly comprising an inner ring and an outer ring, and a cap.

3. The temperature and pressure valve of claim 2, wherein:
the body, the inlet, and the outlet are integrally constructed in a single housing; and
the O-ring, O-ring protector, the grab ring, and the sleeve assembly are installed in the single housing.

4. The temperature and pressure valve of claim 3, wherein the cap engages the single housing to secure the O-ring, O-ring protector, the grab ring, and the sleeve assembly to the single housing.

5. The temperature and pressure valve of claim 4, wherein the push-to-connect fitting is configured to receive a tubular member, and the sleeve assembly is configured to align the tubular member so as to be in fluid communication with the outlet when the push-to-connect fitting receives the tubular member.

6. The temperature and pressure valve of claim 5, wherein the grab ring is configured to secure the tubular member in the outlet and the O-ring is configured to prevent the fluid from leaking between the tubular member and the outlet when the push-to-connect fitting receives the tubular member.

7. A water heater comprising:
a tank configured to store fluid;
a discharge port in fluid communication with the tank; and
a temperature and pressure valve coupled to the discharge port, the temperature and pressure valve comprising:
an inlet extending from a body and in fluid communication with the discharge port;
an outlet extending from the body and housing a push-to-connect fitting; and
a valve positioned between the inlet and the outlet and movable between a closed position and an open position, the valve configured to move from the closed position to the open position when the fluid exceeds at least one of a threshold pressure and a threshold temperature, the inlet and the outlet being in fluid communication when the valve is in the open position.

8. The water heater of claim 7, wherein the push-to-connect fitting comprises an O-ring, an O-ring protector, a grab ring, a sleeve assembly, and a cap.

9. The water heater of claim 8, wherein the body, the inlet, and the outlet of the temperature and pressure valve are formed as a single housing; the O-ring, the O-ring protector, the grab ring, and the sleeve assembly are installed in the single housing, and the cap secures the O-ring, the O-ring protector, the grab ring, and the sleeve assembly to the single housing.

10. The water heater of claim 9, wherein the push-to-connect fitting is configured to receive a tube; and the sleeve assembly is configured to align the tube in fluid communication with the outlet, the grab ring is configured to substantially secure the tube in the outlet, and the O-ring is configured to substantially prevent the fluid from leaking between the tube and the outlet when the push-to-connect fitting receives the tube.

11. The water heater of claim 9, wherein the grab ring comprises:
an outer rim that defines a central channel; and
a plurality of teeth extending from the outer rim into the central channel.

12. The water heater of claim 9, wherein the outlet of the temperature and pressure valve is substantially cylindrical and comprises:
an outside end;
a wall extending from the body to the outside end and having an inner surface and an outer surface;
a first section having a first radius;
a second section positioned between the first section and the outside end and having a second radius, the second radius larger than the first radius; and
an inner ledge on the inner surface and an outer ledge on the outer surface, the inner ledge and the outer ledge defining a transition from the first section to the second section,
wherein the O-ring abuts the inner ledge, the O-ring protector abuts the O-ring, the grab ring abuts the O-ring protector, and the sleeve assembly abuts the grab ring; and
wherein the cap is crimped to engage the outer ledge.

13. A method of manufacturing a temperature and pressure valve, comprising:
forming a body as a single housing, the body comprising an inlet and a substantially cylindrical outlet, the inlet in fluid communication with the outlet and the outlet having:
an outside end;
a wall extending from the body to the outside end and having an inner surface and an outer surface;
a first section having a first radius;
a second section positioned between the first section and the second end and having a second radius, the second radius larger than the first radius; and
an inner ledge on the inner surface and an outer ledge on the outer surface, the inner ledge and the outer ledge defining a transition from the first section to the second section, and;
installing a push-to-connect fitting in the outlet.
